(19) United States
(12) Patent Application Publication
(10) Pub. No.: US 2014/0316708 A1
(43) Pub. Date: Oct. 23, 2014

(54) Oriented Wireless Structural Health and Seismic Monitoring

(71) Applicant: The Board of Trustees of the Leland Stanford Junior University, Palo Alto, CA (US)

(72) Inventors: Mark G. Mollineaux, Stanford, CA (US); Ram Rajagopal, Palo Alto, CA (US); Anne S. Kiremidjian, Los Altos Hills, CA (US)

(21) Appl. No.: 14/256,952

(22) Filed: Apr. 19, 2014

Related U.S. Application Data
(60) Provisional application No. 61/813,829, filed on Apr. 19, 2013.

(51) Int. Cl. G01V 1/30

(52) U.S. Cl. CPC G01V 1/307
USPC 702/15

(57) ABSTRACT

A sensor for structural health monitoring includes a tri-axis microelectromechanical systems (MEMS) accelerometer and a tri-axis MEMS gyrometer. Sampled 3D accelerometer data and 3D gyrometer data are processed using integration and sensor fusion to produce an estimate of 3D rotation of the sensor device and an estimate of 3D displacement of the sensor device expressed in a global reference frame. The sensor measurements may also be corrected using structural model information. Optionally, the sensor may include a tri-axis MEMS magnetometer and use the 3D magnetometer data to increase the accuracy of the estimates. The sensor transmits the estimates wirelessly to a central unit for assessing structural damage.

### CROSS-REFERENCE TO RELATED APPLICATIONS

This application claims priority from U.S. Provisional Patent Application 61/813829 filed Apr. 19, 2013, which is incorporated herein by reference.

### STATEMENT OF GOVERNMENT SPONSORED SUPPORT

This invention was made with Government support under grant no. 1116377 awarded by the National Science Foundation. The Government has certain rights in this invention.

### FIELD OF THE INVENTION

The present invention relates generally to methods and systems for structural health monitoring and seismic monitoring. More specifically it relates to improved sensors and sensing techniques used in such systems.

### BACKGROUND OF THE INVENTION

Structural health monitoring (SHM) is emerging as an important field in assessing the seismic damage to civil structures. Immediately following a large earthquake, information obtained from a SHM system can be rapidly transmitted to decision-makers in order to assist in the deployment of emergency response crews and to determine whether critical structures (e.g., bridges, hospitals) can remain operational. This rapid compilation of structural health information may significantly reduce the seismic hazard due to aftershocks. Later, SHM systems can augment traditional site inspections in order to help make the appropriate repair or occupancy decision.

In order for an SHM system to provide accurate damage assessments, it needs to be based on one or more damage measures (DM) that are well correlated with seismic damage. For example, one common metric for seismic damage to civil structures is the residual drift ratio. Large residual drifts (permanent displacements) are indicative of structural damage; furthermore the residual drift itself weakens the structure through the gravity force and displacement effect known as P-Δ effect. Identification of permanent drift is one of the first steps in preliminary post-earthquake building inspection, and residual story drift can be used to determine the damage state of frame structures. Unfortunately, existing sensors and sensing techniques for measuring drift and other damage measures suffer from various types of limitations, such as sensor inaccuracies.

U.S. Pat. No. 6,292,108, which is incorporated herein by reference, discloses a SHM system having self-powered sensor units that measure acceleration using MEMS accelerometers and transmit the accelerometer data to a central unit for processing. This sensing technique, and other similar techniques, however, can produce significant errors in the damage measures under certain realistic scenarios. Accordingly, there is a need for improved sensors and sensing techniques for such SHM systems.

### SUMMARY OF THE INVENTION

Conventional structural monitoring and seismic measurements which only offer acceleration response are incapable of correcting for changes in sensor orientation. These conventional structural health monitoring sensors and sensing techniques report displacements and rotations in their local reference frame based on accelerometer measurements. These reported data are useful provided the displacements and rotational angles are small. In reality, however, sensors may experience large rotations and displacements, and in this case the data no longer accurately represent the sensor displacement and rotation in a global frame of reference due to a discrepancy between the local sensor reference frame and the fixed global reference frame. Consequently, use of such sensor measurements can lead to inaccurate assessments of structural damage.

For example, in major seismic events, the sensor rotation can be large. Consequently, the local frame of the sensor is rotated with respect to the global frame, so that the error in the reported acceleration data can be significant. Current sensors are also limited in that they only report final, residual displacement, which often has error of 15%.

Embodiments of the present invention use a sensor fusion technique that combines data from a triaxial accelerometer, a triaxial gyrometer, and a triaxial magnetometer to produce globally-referenced displacement and rotational measurements, thereby overcoming the problems with conventional sensing techniques. The sensors are preferably implemented on a single chip using MEMS technology. The sensor chip is coupled to a microprocessor, a wireless radio transmitter, and a battery to provide a compact, portable sensor device.

The sensor can report not only final, residual displacement with more accuracy but also real-time displacement data, as well as real-time rotational and acceleration data, during a seismic event. These sensors are not limited to monitoring structural damage due to seismic events but also have applications to monitoring structural deformations due to wind or water, and to determining alignment of wind turbine blades.

In one aspect, embodiments of the present invention use orientation measurements provided by the sensors to allow these errors to be corrected. Additionally, corrections are available for ground deformation/slope. Additionally, direct displacement measurement from the sensors allow for the path of structural displacements to be recorded, not just the final (residual) displacement.

For seismic measurements, corrections for large angle discrepancies can be determined using techniques of the present invention. Without correction, these large-angle discrepancies result in inaccurate measurements of acceleration, as the position and orientation of the sensor itself changes during the movement. For ground motions, corrections for non-level ground action are achievable by measuring to global frame, instead of local frame. Sensor techniques according to embodiments of the present invention can measure direct displacement, the movement of a point in space through three dimensions, and can track entire path history of any point. This is a large advantage over prior methods of calculating residual drift in a structure, which provide only a final displacement after the structure is done deforming, which does not necessarily represent the maximum displacement during a seismic event. The techniques of the present invention are applicable to SHM systems of all types, and are especially valuable in structures that experience large rotations and/or displacements by providing increased accuracy and more effective damage sensitive features.

In preferred embodiments, the sensors may be implemented using low cost, MEMS sensors, with user-friendly interface. Wireless communication allows for convenient, cheap installation. The sensing technique provides more accurate measurements (acceleration), and new types of measurements for SHM (direct-displacement, and direct-displacement related DSFs). It is efficient and configurable for different applications. Monitoring wind turbine towers and blades is an example of a non-seismic application.

In one aspect, the invention provides a method for measuring data for structural health monitoring. The method includes sampling by a microprocessor signals from a tri-axis microelectromechanical systems (MEMS) accelerometer and a tri-axis MEMS gyrometer to produce 3D accelerometer data and 3D gyrometer data, respectively. The tri-axis

MEMS accelerometer and the tri-axis MEMS gyrometer are rigidly mounted together with the microprocessor, a wireless transmitter, and a battery to form a portable sensor device. The microprocessor processes the 3D accelerometer data and the 3D gyrometer data to produce an estimate of 3D rotation of the sensor device and an estimate of 3D displacement of the sensor device, using sensor fusion filtering that combines the 3D accelerometer data and 3D gyrometer data to correct for sensor errors so that the estimate of 3D rotation and the estimate of 3D displacement are both expressed in a global reference frame. Some embodiments may further include sampling by a microprocessor signals from a tri-axis MEMS magnetometer to produce 3D magnetometer data, and processing to produce the estimate of 3D rotation of the sensor device and the estimate of 3D displacement of the sensor device using sensor fusion filtering that combines the 3D accelerometer data, 3D gyrometer data, and 3D magnetometer data. The method also includes transmitting by the wireless transmitter the estimate of 3D rotation expressed in the global reference frame and the estimate of 3D displacement expressed in the global reference frame. In some embodiments, the processing further produces an estimate of 3D acceleration of the sensor device expressed in the global reference frame, and the transmitting includes transmitting the estimate of 3D acceleration of the sensor device expressed in the global reference frame. The correcting for sensor errors may include correcting for integration error of 3D gyrometer data, local rotation error of the 3D accelerometer data, and gravity bias error of the 3D accelerometer data. In some embodiments, the correcting for sensor errors may include correcting for integration error using Kalman filtering based on structural model information.

### BRIEF DESCRIPTION OF THE DRAWINGS

FIG. 1 is a flowchart outlining the main steps of a method for measuring data for structural health monitoring according to an embodiment of the present invention.

FIG. 2 is a schematic block diagram providing an overview of a structural health monitoring system containing sensors implementing a method according to an embodiment of the present invention.

FIG. 3 is a schematic block diagram of a sensor 300 used in a structural health monitoring system according to an embodiment of the invention.

FIG. 4 is a block diagram illustrating a method for sensor fusion according to an embodiment of the invention.

### DETAILED DESCRIPTION

In one aspect, the present invention provides a wireless sensing system for structural monitoring and seismic response using sensors comprised of gyrometers, accelerometers, and (optionally) magnetometers. Algorithms allow for measurements that are adjusted to the global coordinate system. In one embodiment, the system provides globally referenced acceleration measurements, dynamic orientation angles and displacement together with damage sensitive metrics based on these quantities. One metric, for example, is drift ratio between stories, which is very closely related to damage. Thus, the ability to accurately estimate drift provides a valuable baseline for damage assessment. The ability to obtain sensor displacement estimates maps directly onto calculating estimates of drift ratio between stories by a central unit that receives data from multiple sensor units in the same building. This sensing technique provides additional data and more accurate data that improves structural health monitoring significantly. The sensor corrects for orientation errors in acceleration measurements, and delivers direct displacement measurements directly. This is used to produce more effective Damage Sensitive Features (DSF), to signal damage in a structure.

The invention can be implemented in a number of ways. For example, in one embodiment, a sensor platform has a microprocessor and a tri-axis accelerometer, a tri-axis gyrometer, and a tri-axis magnetometer. The data is fused via a filter. For example, a simple filter uses the result from the magnetometer (angular velocity) to estimate the rotation in the x, y, and z axis that the platform experiences, in reference to the global frame. These results are coupled with the accelerometers' results (an estimate of x and y axis rotation) and the magnetometer results (an estimate of the z axis rotation) so as to correct for the bias that the gyroscope experiences by itself (the integration compounds the noise on the gyroscope, and causes a drift over time). A Kalman filter may be one implementation of such a filter (optimal under certain assumptions) but any number of simpler filters could track the rotation angles. This can be optimized further by using structural assumptions (e.g., what displacements and thereby rotations are possible based upon what structural response is possible). The acceleration response is corrected for local rotations, and corrected for gravity, allowing for the estimate of global displacement through double integration. This is corrected by the same means as above: refining through knowledge about the possible structural response, and filtering through the responses of the other sensors. As for damage diagnosis, the acceleration response is used to extract features that correlate with damage.

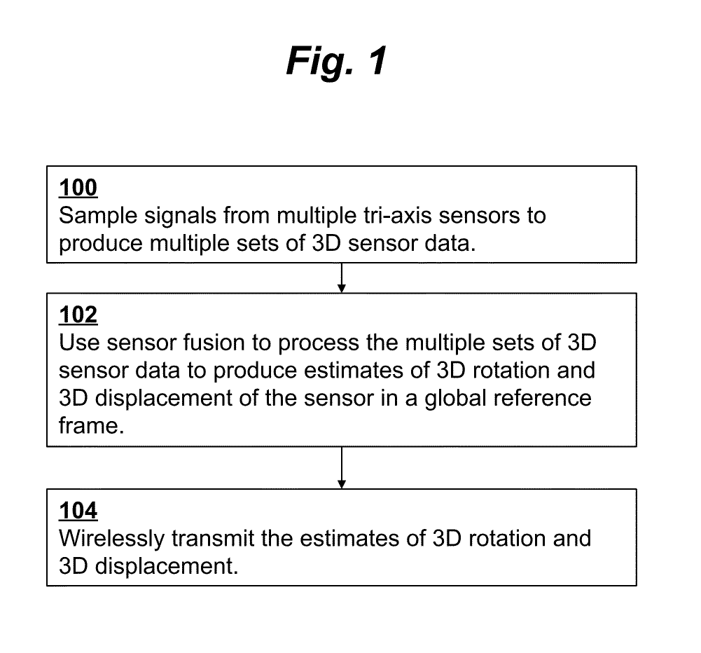

FIG. 1 is a flowchart outlining the main steps of a method for measuring data for structural health monitoring according to an embodiment of the present invention. In step 100 a microprocessor samples signals from multiple tri-axis sensors, e.g., a tri-axis microelectromechanical systems (MEMS) accelerometer and a tri-axis MEMS gyrometer, to produce a temporal sequence of 3D sensor data, e.g., 3D accelerometer data and 3D gyrometer data, respectively. Preferably, the microprocessor polls the sensors at a predetermined sampling rate. Sampling rates are preferably on the order of 100 Hz or more, to capture the frequency response which is generally important for structures. This lower bound also justifies the small-angle assumption, a common trigonometric heuristic which would make many of the estimates much less computationally expensive. In step 102 the microprocessor processes the 3D sensor data to produce an estimate of 3D rotation of the sensor device and an estimate of 3D displacement of the sensor device. The processing uses sensor fusion filtering that combines 3D data from the different sensors to correct for sensor errors so that the estimate of 3D rotation and the estimate of 3D displacement are both expressed in a global reference frame. In step 104 the estimate of 3D rotation expressed in the global reference frame and the estimate of 3D displacement expressed in the global reference frame are transmitted wirelessly, e.g., to a central unit for further analysis and processing together with data from other similar sensors installed in the same structure.

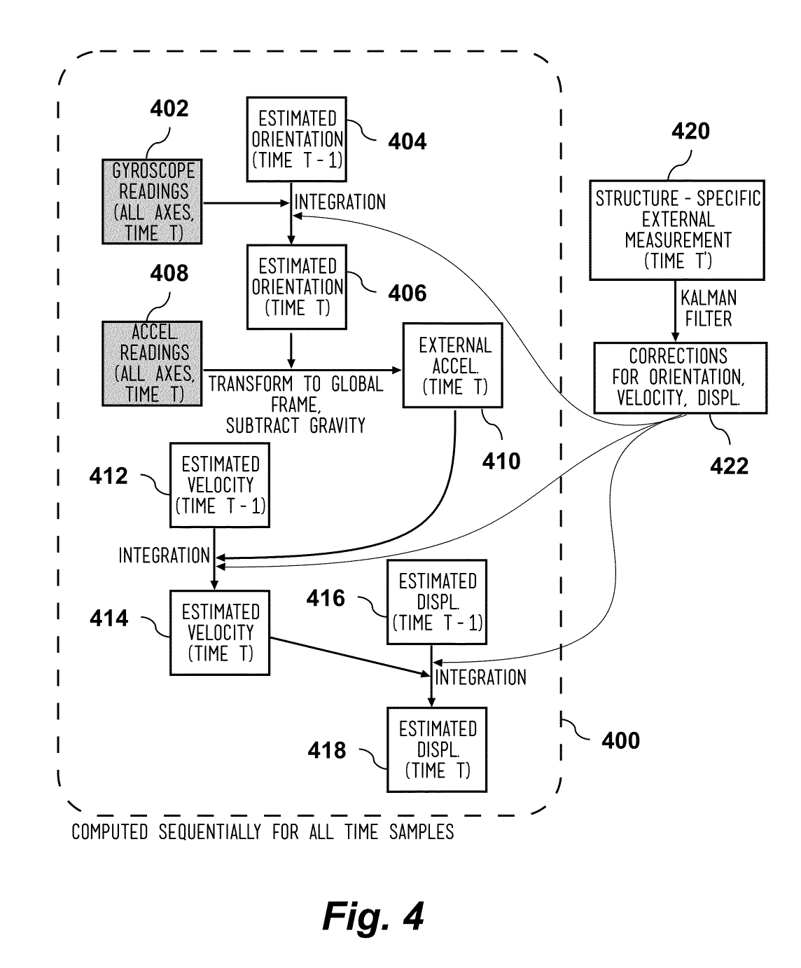

In addition to sampling and processing data from tri-axis accelerometer and gyrometer, the method may also include sampling and processing data from a tri-axis MEMS magnetometer, in which case the sensor fusion filtering combines the 3D accelerometer data, 3D gyrometer data, and 3D magnetometer data to produce the estimates. The processing further may produce an estimate of 3D acceleration of the sensor device expressed in the global reference frame, which is also transmitted together with the other estimates. The correcting for sensor errors may include correcting for integration error of 3D gyrometer data, local rotation error of the 3D accelerometer data, and gravity bias error of the 3D accelerometer data. The correcting for sensor errors may also include correcting for integration error using Kalman filtering based on structural model information. Further details of the techniques for processing data by the sensor will be described below in relation to FIG. 4.

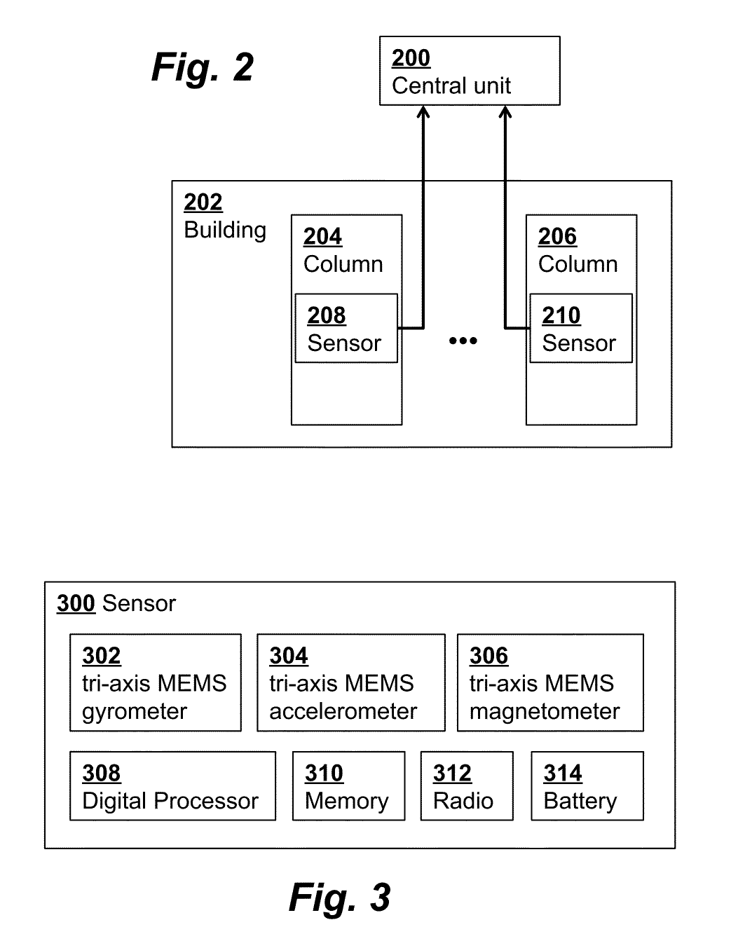

FIG. 2 is a schematic block diagram providing an overview of a structural health monitoring system containing sensors implementing a method according to an embodiment of the present invention. It includes a central unit 200 and multiple sensors 208 through 210 attached to columns 204 through 206 of a building 202. Sensors 208 through 210 communicate wirelessly with central unit 200 over wireless data communications links, as shown. The wireless link may be direct or indirect via multiple intermediate communication links Using data from the multiple sensors 208 through 210, the central unit 200 assesses the structural damage to the building 202. Various techniques known in the art for computing the structural damage to the building may be adapted for use with the sensor data, such as those described in US 20140012517, which is incorporated herein by reference.

FIG. 3 is a schematic block diagram of a sensor 300 used in a structural health monitoring system according to an embodiment of the invention. It includes a tri-axis MEMS gyrometer 302, a tri-axis MEMS accelerometer 304, digital processor 308, memory 310, radio 312, and battery 314. Some embodiments may also include a tri-axis MEMS magnetometer 306. The elements of the sensor 300 are rigidly mounted together to form a portable sensor platform adapted to be mounted on parts of a civil structure, such as on beams or columns.

The sensor platform 300 for SHM is advantageously a small, energy-efficient wireless sensor platform including multiple tri-axis MEMS sensors and an inertial measurement unit (IMU) that produces from the sensor measurements orientation angles for a global coordinate system (pitch, roll, yaw), which in turn are used to correct large-angle discrepancies in acceleration readings. With integration schemes, these are used to make direct displacement measurements for an entire history of a structure. The wireless communication allows for convenient and cost-effective deployment. The SHM preferably includes a simple hub structure with a wired access point communicating as a beacon-transmitting master and all sensor nodes as slaves, designed for reliability and continuous autonomous sensing. The acceleration and displacement measurements reported from the sensors of a structure may be analyzed by a central unit to yield damage sensitive features (DSFs) used in conjunction with decision algorithms to detect damage quickly and reliably. For example, an algorithm may include computing a conditional probability P(Damage State=i|Data) using a progressive damage algorithm, accounting for progression restrictions. The progressive damage algorithm calculates the likelihood that the building is in one of several states of damage, based upon prior estimates of transitions from one damage state to another. The calculation is efficient because it treats the chain of damage states as a Markov model and is able to ignore historical data other than the current state.

FIG. 4 is a block diagram illustrating a method for sensor fusion according to an embodiment of the invention. The group 400 of blocks enclosed in the dashed box are computed sequentially for all time samples. For each time step, tri-axis gyroscope readings 402 and tri-axis accelerometer readings 408 are polled. The 3D gyroscope readings are integrated and combined with a previous 3D orientation estimate 404 to produce a new 3D orientation estimate 406. This orientation estimate 406 is applied to the tri-axis accelerometer readings 408 to transform them from the local frame (as measured) to the global frame to produce 3D globally-referenced acceleration estimate 410, with gravity subtracted, i.e., an estimate of the accelerations induced by external forces. Integrating the acceleration estimate 410 produces a change in velocity which is added to previous velocity 412 to yield an estimate of velocity 414. Integrating the velocity estimate 414 yields a change in displacement which is added to a previous estimated displacement 416 to yield a new estimate of displacement 418.

The integrations above may be subject to drift over time. Accordingly, a correction using structural information is applied. External measurements can offer feedback, as can basic information about the structure itself. For example, a basic pseudomeasurement would be the observation that an element of a building cannot experience a continuous velocity in any direction: buildings are static. Structural feedback could also be based upon knowledge of the stiffness of the structure, which translates into mode shapes—if the mode shapes are known, the displacement that is likely to correspond to a particular orientation angle can be incorporated to improve the estimate. Information about the column and beam stiffnesses for the structure are generally known from building design engineers, and the stiffness of the structural elements and the connections between the elements result in a known deflected shape based upon loadings (for instance, given a ground motion). Based upon a ground motion, an anticipated deflected shape can be determined, which maps the orientation of a point (the placement of the sensor) with displacements, giving correction feedback. The use of a Bayesian filter allows the use of probabilistic correspondences between displacement and orientation angle. Whenever an external measurement 420 is made, the resulting corrections 422 are used at each subsequent time step in the integrations that produce the estimated orientation 406, estimated velocity 414, and estimated displacement 418.

The corrections 422 are tracked through a standard Kalman filter: the state is the error for orientation, velocity, displacement (the expected estimate is always zero for this state vector). When a measurement 420 is obtained, the measurement-portion of the Kalman filter is executed; the relationship between the filter's state and the measurement can be any differentiable function (as in any nonlinear/extended Kalman filter), and is known through particular knowledge of the deployment for SHM, and particular knowledge of the structural elements itself

Embodiments of the invention may also include a magnetometer, in which case magnetometer readings can be used in the estimation of the orientation 406, directly. For example, the estimate of the orientation 406 can use the magnetometer readings together with the integrated gyroscope readings 402 to provide a more accurate estimated orientation 406. Magnetometer can be used in various ways to improve estimates on orientation. For instance, yaw can be estimated as function of roll-estimate, pitch-estimate, and magnetometer-measurements. This can be weighed against the estimate of the yaw that is done through gyro alone. This depends upon the orientation of the sensor—the magnetometer is helpful for improving one reading, depending on how it is installed, analogous to a compass.

The particular transducers are not necessarily limited to those described above. Different transducers are possible. For example, a MEMS inclinometer can directly measure tilt. Those skilled in the art will also appreciate that various other substitutions may be made to realize the principles of the invention. In addition, various filtering techniques may be used for the sensors, as well as various techniques for wireless communication between sensors and base stations.

1. A method for measuring data for structural health monitoring, the method comprising:
sampling by a microprocessor signals from a tri-axis microelectromechanical systems (MEMS) accelerometer and a tri-axis MEMS gyrometer to produce 3D accelerometer data and 3D gyrometer data, respectively; wherein the tri-axis MEMS accelerometer and the tri-axis MEMS gyrometer are rigidly mounted together with the microprocessor, a wireless transmitter, and a battery to form a portable sensor device;
processing by the microprocessor the 3D accelerometer data and the 3D gyrometer data to produce an estimate of 3D rotation of the sensor device and an estimate of 3D displacement of the sensor device, wherein the processing uses sensor fusion filtering that combines the 3D accelerometer data and 3D gyrometer data to correct for sensor errors so that the estimate of 3D rotation and the estimate of 3D displacement are both expressed in a global reference frame;
transmitting by the wireless transmitter the estimate of 3D rotation expressed in the global reference frame and the estimate of 3D displacement expressed in the global reference frame.

2. The method of claim 1
further comprising sampling by a microprocessor signals from a tri-axis MEMS magnetometer to produce 3D magnetometer data, wherein the tri-axis MEMS magnetometer is rigidly mounted in the portable sensor device;
wherein the processing produces the estimate of 3D rotation of the sensor device and the estimate of 3D displacement of the sensor device using sensor fusion filtering that combines the 3D accelerometer data, 3D gyrometer data, and 3D magnetometer data.

3. The method of claim 1
wherein the processing further produces an estimate of 3D acceleration of the sensor device expressed in the global reference frame, and wherein the transmitting comprises transmitting the estimate of 3D acceleration of the sensor device expressed in the global reference frame.

4. The method of claim 1
wherein the correcting for sensor errors comprises correcting for integration error of 3D gyrometer data, local rotation error of the 3D accelerometer data, and gravity bias error of the 3D accelerometer data.

5. The method of claim 1
wherein the correcting for sensor errors comprises correcting for integration error using Kalman filtering based on structural model information.
